(19) United States
(12) Patent Application Publication
(10) Pub. No.: US 2012/0086772 A1
(43) Pub. Date: Apr. 12, 2012

(54) CLOSED CAPTIONING FOR 3D TELEVISION

(75) Inventors: Peter Shintani, San Diego, CA (US); Jun Yonemitsu, Kanagawa (JP)

(73) Assignee: SONY CORPORATION

(21) Appl. No.: 12/901,030

(22) Filed: Oct. 8, 2010

(51) Int. Cl. H04N 13/00; H04N 7/00

(52) U.S. Cl. 348/42; 348/E13.001; 348/468

(57) ABSTRACT

First and second closed captioning (CC) windows containing identical text are presented on a video display slightly offset from each other so as to give a 3D appearance to the combined text.

### FIELD OF THE INVENTION

The present application is directed to closed captioning for three dimensional (3D) televisions or other display.

### BACKGROUND OF THE INVENTION

Closed captioning in TV programming is a convenient feature for many people and indeed is required by regulations. As recognized herein, closed captioning is expected to be required in three dimensional (3D) programming and presents a challenge to implement.

### SUMMARY OF THE INVENTION

Accordingly, a TV has a display, a processor communicating with a TV tuner and controlling presentation on the display, and a computer readable storage medium accessible to the processor and storing logic. The logic causes the processor to present first and second closed captioning (CC) windows on the display. Each window contains the same text as the other window. The text is generated based on audio in TV programming. The processor combines the first window with the second window within a video presentation on the TV. The windows almost but do not completely overlap each other either in space or time to thereby give a 3D appearance to the text.

Specifically, the closed captioning text windows preferably are presented on the display as appropriate for the particular 3D technology used by the display. For example, for displays that use frame sequential technology in combination with shuttered liquid crystal display (LCD) glasses, the first CC window is presented in a first video frame which is for one eye while the second CC window is presented in the temporally next video frame which is for the other eye.

In contrast, for displays that use “x-pol” or parallel barriers, the first CC window is presented on odd lines while the second CC window is presented simultaneously with the first CC window but on even lines of the display. Yet again, for displays that use circular polarization, the first CC window is presented using a clockwise projector while the second CC window is presented simultaneously with the first CC window but using a counterclockwise projector to render a polarized feed before combination to the final output.

In example embodiments, the first and second CC windows are identically sized and configured. If desired each window may be a billboard window containing text rendered on a semi-transparent video panel.

In non-limiting implementations the position of the text in the first window relative to the first window is identical to the position of the text in the second window relative to the second window.

In one example, the CC windows are horizontally offset from each other. In this example, the first CC window is presented on the display with its left edge just to the left of a left edge of the second CC window, and with the right edge of the first CC window being just to the left of a right edge of the second CC window. The top edges of the windows are coincident with each other and the bottom edges of the windows are coincident with each other. In this last example, letters in text in the first CC window are offset slightly to the left of letters in the text in the second CC window.

In another aspect, a method includes deriving closed captioning (CC) text representative of audio in a video program. The method includes arranging the text in a first CC window, arranging the text in a second CC window, and simultaneously presenting both windows in the video program slightly offset from each other to give a 3D appearance to the text.

In another aspect, an assembly includes a display receiving 3D video signals and a processor communicating with the display. A computer readable medium bears instructions executable by the processor to cause first and second closed captioning (CC) windows containing identical text to be slightly offset on the display from each other so as to give a 3D appearance to the combined text.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a flow chart of example logic; and

FIG. 3 is an example screen shot illustrating present CC principles.

### DETAILED DESCRIPTION OF THE PREFERRED EMBODIMENT

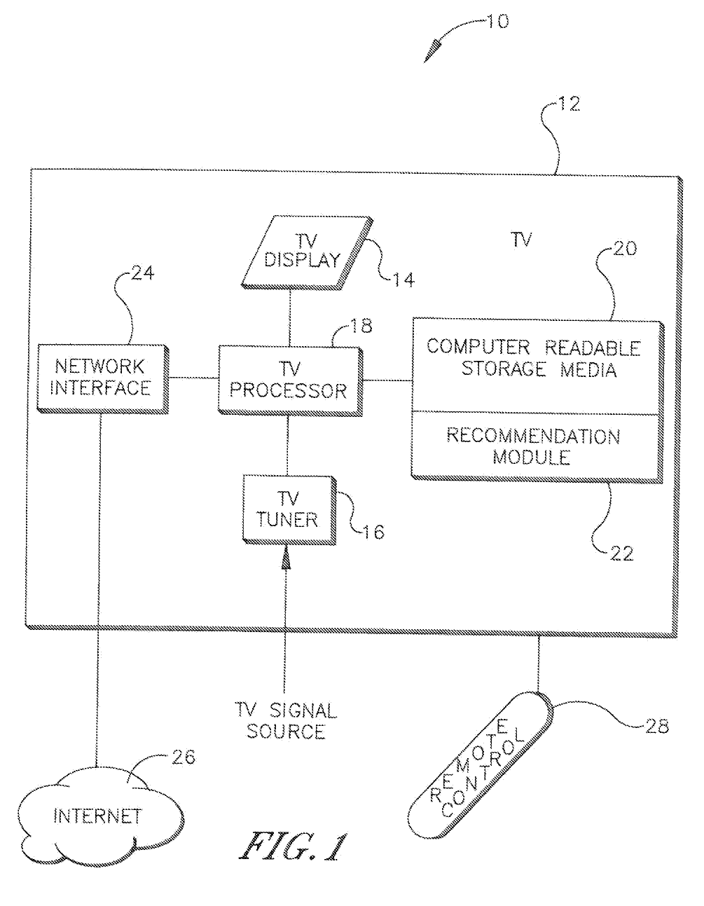

Referring initially to FIG. 1, an assembly 10 is shown which includes a TV chassis 12 bearing a TV display 14 such as a standard definition and/or high definition matrix display. The display 14 presents video from a TV tuner 16 which may be in the chassis 12 as shown or which may be implemented in a separate set-top box. The TV tuner 16 receives TV signals from one or more TV sources including satellite receivers, cable head ends, and terrestrial broadcast transmitters.

A TV processor 18 communicates with the TV tuner 16 and with the display to control presentation on the display. The TV processor 18 accesses one or more computer readable storage media 20 such as but not limited to disk-based and/or solid state storage to execute instructions thereon.

The TV processor may also communicate with a network interface 24 within the chassis 12. The network interface 24 may be, without limitation, a wired or wireless modem or other appropriate interface to communicate with a wide area network such as the Internet 26, from which additional content such as Internet Protocol TV (IPTV) content, “widgets”, etc. may be downloaded. A user can input user control signals to the processor for selection and cursor navigation using a remote control (RC) 28.

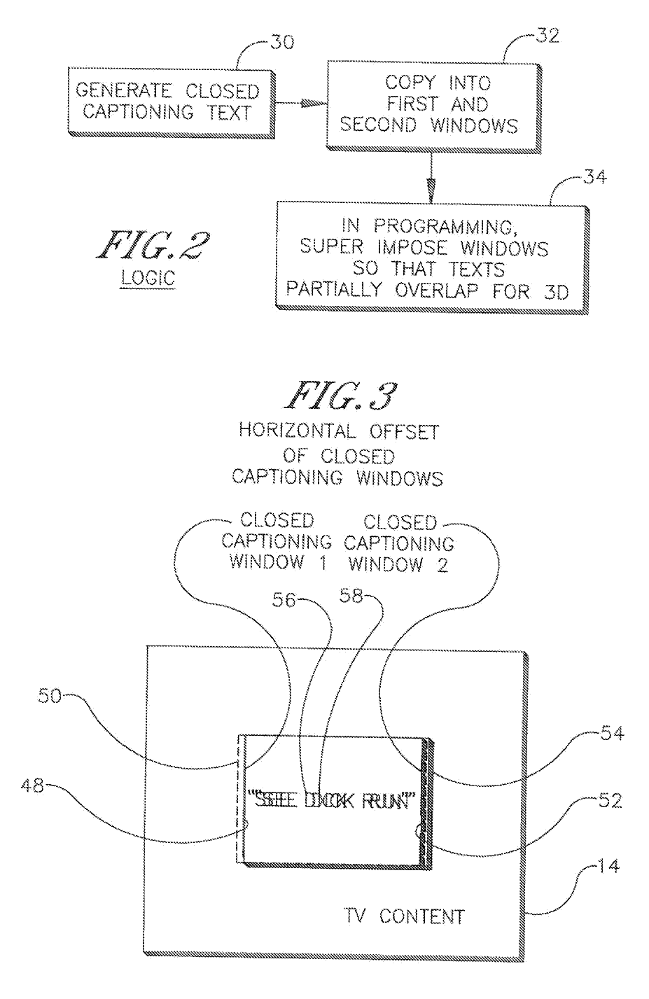

Now referring to FIG. 2, at block 30 closed captioning text is generated based on audio in TV programming. At block 32, the text is copied into first and second closed captioning (CC) windows which preferably may be identically sized and configured. If desired, the two windows may be so-called “billboard” windows, essentially containing text rendered on a semi-transparent video panel.

Accordingly, each window contains the identical text as the other window. Furthermore, the position of the text in a window relative to that window is identical to the position of the text in the opposite window relative to that opposite window.

With this arrangement, at block 34 the two windows are superimposed upon each other, almost but not completely overlapping. This means, in turn, that the text of one window is closely juxtaposed with but does not completely cover the text in the other window, since the text positions relative to their windows is the same but the windows are marginally offset from each other. In this way, a 3D appearance of the text is rendered.

Note that the overlapping above may be temporally or spatially. For example, for displays that use frame sequential technology in combination with shuttered liquid crystal display (LCD) glasses, the first CC window is presented in a first video frame which is for one eye while the second CC window is presented in the temporally next video frame which is for the other eye, in which case the windows appear to overlap spatially but do not overlap each other in time.

In contrast, for displays that use “x-pol” or parallel barriers, the first CC window is presented on odd lines while the second CC window is presented simultaneously with the first CC window but on even lines of the display, in which case the windows overlap in time. Yet again, for displays that use circular polarization, the first CC window is presented using a clockwise projector while the second CC window is presented simultaneously with the first CC window but using a counterclockwise projector to render a polarized feed before combination to the final output.

FIG. 3 provides an illustrative example. In FIG. 3, the CC windows may be horizontally offset as shown. With greater specificity, in FIG. 3, CC window 2 is presented on the display 14 with its left edge 48 just to the left of the left edge 50 of CC window 1 as shown. Likewise, the right edge 52 of CC window 2 is just to the left of the right edge 54 of CC window 1 as shown. The top and bottom edges of the windows are coincident.

Accordingly, letters 56 in the text “See Dick Run” in CC window 2 are offset slightly to the left of letters 58 in the same text in CC window 1. This approximates a 3D appearance of the combined text. As stated above, window 1 and window 2 may be presented in respective “left eye” and “right eye” frames so that they do not overlap each other in time but to the viewer who cannot perceive the fast frame changes, they appear to overlap in an offsetting manner and, hence, give a 3D appearance.

Offsets between the CC windows other than those shown may be used. The CC text may be sent in the TV programming or generated by the TV processor on the fly as it receives the audio and uses voice recognition to translate the audio into text.

While the particular CLOSED CAPTIONING FOR 3D TELEVISION is herein shown and described in detail, it is to be understood that the subject matter which is encompassed by the present invention is limited only by the claims.

What is claimed is:

1. TV comprising:
display;
processor communicating with a TV tuner and controlling presentation on the display;
computer readable storage medium accessible to the processor and storing logic causing the processor to:
present first and second closed captioning (CC) windows on the display, each window containing the same text as the other window, the text being generated based on audio in TV programming; and
overlay the first window onto, the second window within a video presentation on the TV, the windows overlapping each other such that the text of the first window appears to a viewer to be closely juxtaposed with but does not completely cover the text in the second window to thereby give a 3D appearance to the text.

2. The TV of claim 1, wherein the first and second CC windows are identically sized and configured.

3. The TV of claim 1, wherein each window is a billboard window containing text rendered on a semi-transparent video panel.

4. The TV of claim 1, wherein position of the text in the first window relative to the first window is identical to position of the text in the second window relative to the second window.

5. The TV of claim 1, wherein the first window is presented in first frames but not second frames and the second window is presented in second frames but not first frames.

6. The TV of claim 1, wherein the CC windows are horizontally offset from each other.

7. The TV of claim 6, wherein the first CC window is presented on the display with its left edge just to the left of a left edge of the second CC window, a right edge of the first CC window being just to the left of a right edge of the second CC window.

8. The TV of claim 7, wherein the top edges of the windows are coincident with each other and the bottom edges of the windows are coincident with each other.

9. The TV of claim 8, wherein letters in text in the first CC window are offset slightly to the left of letters in the text in the second CC window.

10. Method comprising:
deriving closed captioning (CC) text representative of audio in a video program;
arranging the text in a first CC window;
arranging the text in a second CC window;
presenting both windows in the video program slightly offset from each other to give a 3D appearance to the text.

11. The method of claim 10, wherein the first and second CC windows are identically sized and configured as each other.

12. The method of claim 10, wherein each window is a billboard window containing text rendered on a semi-transparent video panel.

13. The method of claim 10, wherein the first window is presented in first frames but not second frames and the second window is presented in second frames but not first frames.

14. The method of claim 10, wherein the CC windows are horizontally offset from each other.

15. Assembly comprising:
display receiving 3D video signals;
processor communicating with the display; and
computer readable medium bearing instructions executable by the processor to cause first and second closed captioning (CC) windows containing identical text to be slightly offset on the display from each other so as to give a 3D appearance to the combined text.

16. The assembly of claim 15, wherein the first and second CC windows are identically sized and configured as each other.

17. The assembly of claim 15, wherein the CC windows are horizontally offset from each other.

18. The assembly of claim 15, wherein the first and second CC windows are identically sized and configured as each other.

19. The assembly of claim 15, wherein the first window is presented in first frames but not second frames and the second window is presented in second frames but not first frames.

20. The assembly of claim 15, wherein position of the text in the first window relative to the first window is identical to position of the text in the second window relative to the second window.
